(19) United States
(12) Patent Application Publication
(10) Pub. No.: US 2003/0201773 A1
(43) Pub. Date: Oct. 30, 2003

(54) Measuring device, nuclear magnetic reasonance tomograph, measuring method and imaging method

(76) Inventor: Stefan Posse, Duren (DE)

Correspondence Address: CONNOLLY BOVE LODGE & HUTZ, LLP, P O BOX 2207, WILMINGTON, DE, 19899, US

(21) Appl. No.: 10/412,263

(22) Filed: Apr. 14, 2003

Related U.S. Application Data
(62) Division of application No. 09/806,847, filed on May 15, 2001, now abandoned.
Application No. 09/806,847 is a 371 of international application No. PCT/DE99/03280, filed on Oct. 12, 1999.

(30) Foreign Application Priority Data
Oct. 12, 1998 (DE) 198 46 869.5

(51) Int. Cl. G01V 3/00

(52) U.S. Cl. 324/307; 324/309

(57) ABSTRACT

The invention relates to a measuring device which comprises at least one recording means for recording measurement signals, and a transformation means for transforming the measurement signals into digital measurement data. According to the invention, the measuring device is characterized in that the recording means and/or the transformation means are designed in such a way that they record measurement signals with a different resolution at different times and/or at different locations and/or they transform the measurement signals differently.

The invention relates to a measuring device which comprises at least one recording means for recording measurement signals, and a transformation means for transforming the measurement signals into digital measurement data.

In particular, the invention relates to measuring devices which allow the execution of an imaging method. An imaging method is a method in which measurement signals are used to generate at least one image. With the imaging method, normally acquired raw data is transformed into desired image information by means of a suitable transformation, especially a two-dimensional or three-dimensional Fourier transform.

The invention also relates to a method in which measurement signals are recorded and transformed into digital measurement data and to an imaging method. In particular, the invention relates to a nuclear magnetic resonance tomograph.

Nuclear magnetic resonance spectroscopy (NMR) (also known as zeugmatography) is employed in order to obtain spectroscopic information about a substance. A combination of nuclear magnetic resonance spectroscopy with the techniques of nuclear magnetic resonance imaging (MRI) provides a spatial image of the chemical composition of the substance.

Particularly in medical research, there is a need for information about brain activity or, in a broader sense, for information about blood flow or changes in the concentration of deoxyhemoglobin in the organs of animals and humans. Neuronal activation is manifested by an increase of the blood flow into activated regions of the brain, whereby a drop occurs in the concentration of deoxyhemoglobin in the blood. Deoxyhemoglobin (DOH) is a paramagnetic substance that reduces the magnetic field homogeneity and thus accelerates the T₂^{*} signal relaxation. It is primarily the protons of hydrogen in water that are excited.

A localization brain activity is made possible by conducting an examination with functional imaging methods that measure the change in the NMR signal relaxation with a time delay (echo time). This is also referred to as a susceptibility-sensitive measurement. The biological mechanism of action is known in the literature under the name BOLD effect (Blood Oxygen Level Dependent effect) and, in susceptibility-sensitive magnetic resonance measurements at a field strength of a static magnetic field of, for example, 1.5 tesla, it leads to image brightness modulations of up to 10% in activated regions of the brain. Instead of the mechanism of action detected with the endogenous contrast agent DOH, other mechanisms of action can also occur that, by means of exogenous contrast agents, cause changes in the susceptibility.

Rapid magnetic resonance imaging (MRI) and magnetic resonance spectroscopy (MRS) make it possible to study the BOLD in vivo as a function of activation states of the brain; in this context, see S. Posse et al.: Functional Magnetic Resonance Studies of Brain Activation; Seminars in Clinical Neuropsychiatry, Volume 1, No. 1, 1996; pages 76 through 88.

NMR imaging methods select slices or volumes that yield a measurement signal under appropriate irradiation with high-frequency pulses and under the application of magnetic gradient fields; this measurement signal is digitized and stored in a two-dimensional or three-dimensional field in the measuring computer.

Two-dimensional or three-dimensional Fourier transform from the raw data collected then serves to acquire (reconstruct) the desired image information in pixels or in voxels. A reconstructed slice image consists of pixels (picture elements), and a volume data set consists of voxels (volume elements). A pixel is a two-dimensional picture element, for instance, a square.

The image is made up of pixels. A voxel is a three-dimensional volume element, for example, a cube which, for metrological reasons, does not exhibit any sharp boundaries. The dimensions of a pixel normally lie in the order of magnitude of 1 nm², and those of a voxel in the order of magnitude of 1 nm³. The geometries and dimensions can vary.

By comparing the signal course in every pixel, which has been measured by means of functional imaging, with the time course of a model function, a stimulus-specific neuronal activation can be detected and spatially localized. A stimulus can be, for instance, a somatosensorial, acoustic, visual or olfactory stimulus as well as a mental or motor task. The model function or the model time series describes the anticipated signal change of the magnetic resonance signal resulting from neuronal activation. These can be derived, for example, by means of empirical rules from the paradigm of the experiment in question. The essential aspect is to take into consideration a time delay of the model function with respect to the paradigm (sluggish reaction of the blood flow in response to neuronal activation).

It is already known how brain activation can be depicted by activation images acquired from nuclear spin tomographic data. The activation images can even be calculated and displayed in real time, that is to say, a data set can be converted into an image before the next data set is measured. Here, the time interval is typically 1 to 3 seconds.

The invention has the objective of configuring a measuring device of the known type in such a way that it is suitable for recording various measurement signals at the highest possible resolution.

According to the invention, this objective is achieved in that the recording means and/or the transformation means is designed in such a way that they record measurement signals within a different resolution at different times and/or at different locations and/or they transform the measurement signals differently.

The measurement data can be selected particularly effectively in that the measuring device is designed in such a way that it comprises at least one control unit for controlling the recording means and/or the transformation means.

The control unit can be, for instance, a computer or a computer component. The term “computer” should not be construed in any limiting manner whatsoever. It can refer to any unit that is suitable for performing computations, for example, a work station, a personal computer, a microcomputer or else a circuitry arrangement suitable for performing computations.

A particularly advantageous embodiment of the measuring device is characterized in that it encompasses at least one memory unit, whereby this memory unit contains information for the changeable transformation of the measurement signals into the measurement data.

The term “memory unit” is employed here in a broad sense. The embodiment of the memory unit is not crucial since it is only necessary to store values. For example, the memory unit has suitable memory cells of the kind preferably known as static, dynamic or non-volatile memory in semiconductor technology.

Another subject matter of the invention is to carry out a method of the known type in such a way that measurement signals are recorded with a different resolution at different times and/or different locations and/or are differently transformed.

It is particularly advantageous to carry out the method in such a way that the measurement signals are differently recorded and/or differently transformed to an extent that corresponds to at least one model.

The model describes an actual course of the measurement signals or an expected course of the measurement signals or else a combination of an anticipated course of the measurement signals and an actual course of the measurement signals. For instance, this is a model function that assigns an extent to a measurement signal in that the signal is transformed into the measurement data. However, a direct computation of the extent is not necessary since it can also be approximated using in a suitable manner or else it can be replaced with especially advantageous value according to a table.

The model indicates, for example, the extent to which the measurement signals are stored and/or transformed into the digital measurement data.

It is likewise advantageous for the model to determine the resolution with which the measurement signals are recorded.

An advantageous embodiment of the method is characterized in that the model is defined prior to the measurement.

Another likewise advantageous embodiment of the method according to the invention is characterized in that the model is changed during the measurement.

A further improvement of the measuring sensitivity can be achieved in that the model is changed on the basis of a previously defined starting model.

This is done, for example, in that the resolution with which signals are recorded and/or transformed are varied in terms of the time and/or location.

It is particularly advantageous to compress the measurement signals and/or the measurement data. The compression factor can be varied over the course of the measurement. Such a variation is especially practical in the case of measurement series in which the activation and resting times vary. A higher compression factor can be selected for the resting times.

Especially advantageous areas of application for the invention are cited below. In particular, they relate to a measuring device employed in an imaging method.

By means of the measuring device, reconstructed slice images or volume data sets are ascertained from the measurement signals from at least one sample.

The imaging method can be, for example, a spectroscopic imaging method, especially nuclear magnetic resonance spectroscopy. However, by the same token, the imaging method can also be employed in other areas such as, for instance, to graphically depict ultrasound examinations. Since such examinations usually take place in vivo, it is practical that the imaging method is suitable to be performed in actual measuring time, that is to say, in real time.

In particular, a rapid spectroscopic imaging method is achieved which ascertains changes in the NMR signal relaxation.

This spectroscopic imaging method is preferably a spectroscopic echo-planar imaging method. Spatial encoding takes place within the shortest possible time span that is repeated several times during one signal decay and normally ranges from 10 ms to 100 ms. The multiple repetition of the echo-planar encoding during one signal decay depicts the course of the signal decay in the sequence of reconstructed individual images.

The number of images that are encoded during the signal decay is dependent on the relaxation time and on the encoding time Δt for a single image.

In order to detect changes in the relaxation with the greatest possible level of sensitivity, a criterion has been found for the optimal selection of the measuring-time window as a function of the relaxation time constants, of the encoding time for a single image and of the type of data processing.

The criterion consists of observing a differential signal between various states of relaxation.

The differential signal has a time-related maximum value that lies close to the mean relaxation time when small relaxation changes are involved.

Preferred evaluation methods, additional advantages, special features and practical improvements of the invention can be gleaned from the presentation below of preferred embodiments of the invention with reference to example computations and to drawings.

The drawings show the following:

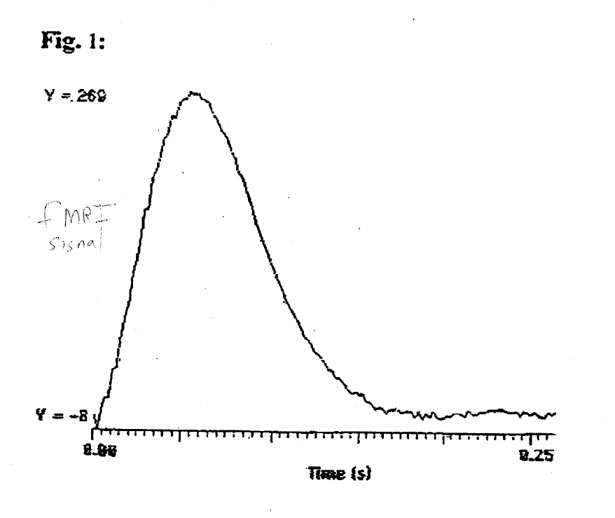

FIG. 1—an experimental differential signal of a functional change in relaxation time in a selected image element as a function of the measuring time following signal stimulation;

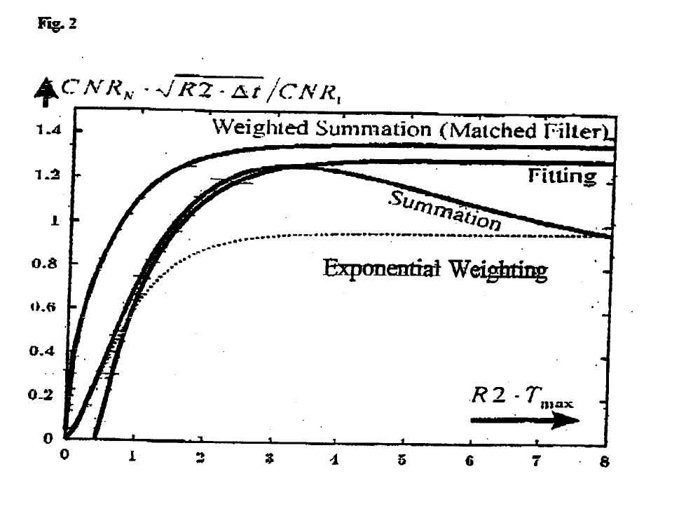

FIG. 2—a relative, scaled increase of the contrast-to-noise ratio CNR_{N} in comparison to the contrast-to-noise ratio CNR₁ of an individual measurement for various evaluation methods as a function of the measurements;

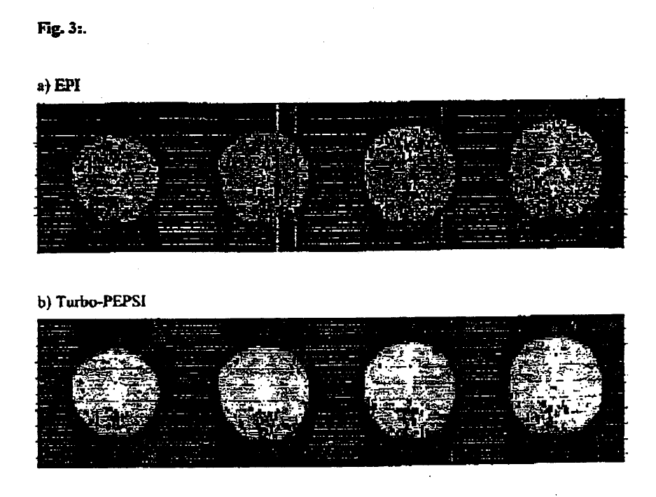

FIG. 3—in a first partial image A, a detection of brain activation in four stages by means of a conventional imaging method and, in a partial image B, a detection of brain activation using a method according to the invention.

The preferred embodiments of the invention especially provide for the detection of a differential signal at various points in time. These points in time lie within a time interval tᵢ.

In particular, this is a differential signal between a relaxation curve in an excited state and a relaxation curve in a baseline state.

As an example, FIG. 1 depicts a differential signal (vertical axis) between a functional relaxation time change (fMRI signal) in the human brain in a selected image element in the visual cortex during a visual stimulation with an oscillating light as a function of the measuring time following signal excitation (horizontal axis) measured by means of rapid spectroscopic imaging.

This is a particularly simple case in which the differential signal is formed by a difference signal from a relaxation signal during an activation and from a relaxation signal during a state of rest. The term “differential signal”, however, is by no means limited to difference signals, but rather—like the term “differential function”—it encompasses all cases in which differences between measured curves are ascertained or evaluated.

The measurement is first carried out with time intervals ranging from 10 to 100 milliseconds, for example, 18 milliseconds, between the measuring points. The fMRI signals are ascertained by means of nuclear spin tomographic examinations of the brains of test subjects. A source of light, especially a matrix of light-emitting diodes (LED), is positioned directly in front of the face of the test subjects and then excited so as to emit flash signals. The frequency of excitation is preferably about 8 Hz. The effect of the signal flashes is exerted over a time interval—synchronized with the carrier signal from a scanner—of several seconds, for instance, 5 seconds, which is followed by a rest interval of approximately the same duration. The scanner is a Vision 1.5 Tesla, full-body scanner made by Siemens Medical Systems of Erlangen, Germany, in the standard version with a magnetic field gradient of 25 mT/m. Such a scanner is able to switch over gradient fields within about 150 μs.

The imaging method is preferably an echo-planar imaging method, for instance, conventional echo-planar imaging (EPI).

This method comprises, for example, the repeated use of two-dimensional echo-planar image encoding. Spatial encoding takes place within the shortest possible time span that is repeated several times during one signal decay and preferably ranges from 20 ms to 100 ms. The multiple repetition of the echo-planar encoding during one signal decay depicts the course of the signal decay in the sequence of reconstructed individual images. Such a likewise advantageous implementation of the method according to the invention is preferably done by means of PEPSI (proton echo planar spectroscopic imaging).

In an advantageous embodiment of the method, the resolution is adapted to the strength of the relaxation signals. If there are several similar signals whose differential signal is to be examined, however, it is even more advantageous to adapt the resolution to the differential function. In this context, the functional relationship between the resolution and the differential function is preferably selected in such a way that, in the case of a larger signal, the value for the resolution is higher.

Assuming an exponential drop of the relaxation curves, the following results for the differential signal ΔS (t) depicted in FIG. 1:

ΔS(t)=S₀(e^{-t/T}^{₂}^{^{*}}^{(a)}−e^{-t/T}^{₂}^{^{*}}^{(b)}) (1),

wherein T₂^{*}(a) and T₂^{*}(b) are relaxation time constants in an activated state (a) and in a baseline state (b) and wherein S₀ stands for an initial signal intensity.

Assuming a slight change of the relaxation time ΔT₂^{*}, the signal differential ΔS (t) is:

$$Δ S ( t ) \approx {S}_{0} Δ {T}_{2}^{*} \frac{ⅆ}{ⅆ {T}_{2}^{*}} {ⅇ}^{- t / {T}_{2}^{*}} = {S}_{0} \frac{Δ {T}_{2}^{*}}{{T}_{2}^{*}} \frac{d}{{T}_{2}^{*}} {ⅇ}^{- t / {T}_{2}^{*}} , \qquad ( 2 )$$

wherein T₂^{*} stands for the relaxation time in the baseline state.

An essentially bell-shaped curve is formed that has a maximum value at t=T₂^{*}. With a preferred measuring field strength of about 1.5 tesla, t acquires a typical value of about 70 ms.

The maximum value is:

$$0.37 \frac{Δ {T}_{2}^{*}}{{T}_{2}^{*}} . \qquad ( 3 )$$

In a preferred embodiment of the invention, it is assumed that the noise effects are a so-called white, thermal noise with a mean value close to zero and with a standard deviation σ.

By means of suitable ways to carry out the evaluation method, an elevated signal-to-noise ratio is obtained in comparison to a single-point measurement. Whereas with an individual measurement the contrast-to-noise ratio (CNR) matches the formula

$${CNR}_{1} = 0.37 \frac{{S}_{0}}{\sqrt{2 σ}} \frac{Δ {T}_{2}^{*}}{{T}_{2}^{*}} , \qquad ( 4 )$$

a higher contrast-to-noise ratio can be achieved with the methods to carry out the evaluation procedure presented here.

A first embodiment of a preferred evaluation method calls for the summation of the measured effect for N points in time and then for the formation of an average signal. This average signal yields a good measure of S₀T₂^{*}. Assuming equidistant measuring intervals Δt for each individual measured value acquisition and the same noise strength in each point, the following holds true for the summed up signal (t=i×Δt):

$${\sum }_{i = 1}^{N} Δ S ( i Δ t ) = {S}_{0} \frac{1 - {ⅇ}^{- ( N + 1 ) Δ t / {T}_{2}^{*}}}{1 - {ⅇ}^{- Δ t / {T}_{2}^{*}}} \approx {S}_{0} \frac{Δ {T}_{2}^{*}}{Δ t} [ 1 - {ⅇ}^{- N Δ t / {T}_{2}^{*}} ] , \qquad ( 5 )$$

wherein the inequalities Δt<<T₂^{*} (6) and N>>1 (7) are employed.

A comparatively slight change in T₂, of the kind that occurs, for example, with blood oxidation (BOLD effect—Blood Oxygen Level Dependent effect), manifests itself in the contrast C presented below:

$$C = {S}_{0} Δ {T}_{2}^{*} \frac{ⅆ}{ⅆ {T}_{2}^{*}} {\sum }_{i = 1}^{N} Δ S ( i Δ t ) = {S}_{0} \frac{Δ {T}_{2}^{*}}{Δ t} [ 1 - ( x + 1 ) {ⅇ}^{- x} ] , \qquad ( 8 )$$

wherein x is defined as follows:

$$x ≡ \frac{N Δ t}{{T}_{2}^{*}} . \qquad ( 9 )$$

The noise effects in the summed up signal according to Formula 8 exhibit the following standard deviation:

\sqrt{2N}σ (10).

The contrast-to-noise ratio results as follows:

$${CNR}_{N} = \frac{{S}_{0}}{\sqrt{2} σ} \frac{Δ {T}_{2}^{*}}{{T}_{2}^{*}} \sqrt{\frac{{T}_{2}^{*}}{Δ t}} \frac{[ 1 - ( x + 1 ) {ⅇ}^{- x} ]}{\sqrt{x}} . \qquad ( 11 )$$

As can be seen, for example, in FIG. 2, the contrast-to-noise ratio has a maximum value at x=3.2. FIG. 2 shows the contrast-to-noise ratio (CNR) as a function of the length of the measuring time following signal excitation Tₘₐₓ, of the relaxation rate R2=1/T₂^{*} and of an encoding time Δt for various data evaluation methods: summation of the individual measurements, exponentially weighted summation, optimally weighted summation, weighted filter as well as for a curve adaptation (fitting).

A maximum contrast-to-noise ratio can be achieved when the measurements are performed up to the point in time

T_{Max}=NΔt=3.2T₂^{*} (12).

For a correspondingly selected N, the contrast-to-noise ratio is at a maximum and amounts to a maximum of 0.46 according to the following formula:

$${CNR}_{N} = 0.46 \frac{{S}_{0}}{\sqrt{2} σ} \frac{Δ {T}_{2}^{*}}{{T}_{2}^{*}} \sqrt{\frac{{T}_{2}^{*}}{Δ t}} = 1.2 \sqrt{\frac{{T}_{2}^{*}}{Δ t}} {CNR}_{1} . \qquad ( 13 )$$

For purposes of achieving a further increase in the contrast-to-noise ratio, it is practical to perform a weighted summation of the signal according to Equation 14.

$${\overline{S}}_{r} = {\sum }_{n = 1}^{N} {S}_{r} ( {t}_{n} ) \cdot w ( {t}_{n} ) . \qquad ( 14 )$$

Preferably, a weighting factor w(t_{N}) according to Formula 15 is used in Formula 14.

w(tₙ)=R2tₙ·e^{-R2·t}^{ₙ} (15).

Here, an anticipated relaxation rate is incorporated into the weighting factor w(t_{N}) in a sample to be examined. This rate is preferably the mean relaxation rate in the examined sample.

The following formula results for the contrast-to-noise ratio:

$${CNR}_{N} = \frac{{S}_{0}}{\sqrt{2} σ} \frac{Δ {T}_{2}^{*}}{{T}_{2}^{*}} \sqrt{\frac{{T}_{2}^{*}}{Δ t}} \sqrt{\frac{[ 2 - ( {x}^{2} + 2 x + 2 ) \cdot {ⅇ}^{- 2 x} ]}{8}} . \qquad ( 16 )$$

With this variant of the evaluation method, the increase of the signal-to-noise ratio with the multiple-point measurement acquires a particularly high value of 1.4. Once again, the measuring time preferably amounts to 3.2 T₂^{*}. Such a weighted summation leads to an even better result for the contrast ratio than is the case with a conventional summation.

Already in the simple case—in which the resolution within the bell-shaped curve depicted in FIG. 1 is higher than in other time ranges by a factor of 2—a reduction of the noise by the factor 1/\sqrt{2} is observed.

Another variant of the evaluation method consists of carrying out an adaptation procedure (fit process) by adapting the relaxation curve to exponentially dropping curves.

The advantageousness of the evaluation method according to the invention will be elaborated upon below with reference to an observation of the theory of noise effects as well as with reference to experiments.

The total signal Sᵣ (tₙ) results as follows:

Sᵣ(tₙ)=S₀e^{-R2·t}^{ₙ}+gᵣ(tₙ)+hᵣ(tₙ) (17).

Here, S₀e^{-R2·t}^{ₙ} stands for the pure signal, gᵣ (tₙ) stands for a white noise and hᵣ (tₙ) stands for an influence of physiological noise signals on the sample to be examined, whereby these are preferably signals with a low frequency.

In this context, the index r assumes values from 1 to NR and it stands for the number of repetitions of the relaxation measurements; the index n assumes values from 1 to N and serves to count the number of echo signals during one relaxation measurement.

In order to extract from this measured signal a change in the relaxation as a function of brain activation, various approaches, which are explained with reference to the formulas below, can be adopted.

For a summation via the echo signals, the result is

$${\overline{S}}_{r} = {\sum }_{n = 1}^{N} {S}_{r} ( {t}_{n} ) , \qquad ( 18 )$$

whereas the following formula results for a weighted summation:

$${\overline{S}}_{r} = {\sum }_{n = 1}^{N} {S}_{r} ( {t}_{n} ) \cdot w ( {t}_{n} ) , \qquad ( 19 )$$

whereby the following holds true:

w(tₙ)=R2tₙ·e^{-R2·t}^{ₙ} (20).

Another method is a fit process, as presented with reference to the formula depicted below:

\overline{S}ᵣ={\overline{s}₀ᵣ,\overline{R2}ᵣ} [symbol] Sᵣ(tₙ)≈s₀e^{-R2·t}^{ₙ} (21).

As was the case with the general considerations, here too, it can be assumed that the mean value of the white noise is zero or close to zero. The contrast-to-noise ratio (CNR) results from ΔS divided by the total noise. This is followed by a determination of the differential value for at least two measurements.

According to another preferred embodiment of the invention, a correlation analysis over several relaxation measurements that were made one after the other is performed for every single echo signal. The correlation analysis is done in a known manner in which it is particularly advantageous to proceed as put forward in the article by Peter A. Vandettini et al. in “Magnetic Resonance in Medicine”, Volume 30, pages 161 through 173, 1993, to which reference is made in its entirety.

The anticipated value for the correlation coefficient (c.c) is

$$\begin{matrix}⟨ c . c ⟩ = c . c {.}_{0} [ 1 - \frac{{σ}_{t}^{2}}{2 \overline{Δ {S}^{2}}} ] , wherein & ( 22 ) \\ \overline{Δ {S}^{2}} = \frac{1}{NR} {\sum }_{r = 1}^{NR} Δ {S}_{r}^{2} . & ( 23 )\end{matrix}$$

wherein

The correlation coefficient (c.c) exhibits a standard deviation

$$SD ( c . c . ) = \frac{1}{\sqrt{NR}} \frac{{σ}_{t}}{\sqrt{\overline{Δ {S}^{2}}}} \sqrt{1 - c . c {.}_{0}^{2}} . \qquad ( 24 )$$

This is followed by a combination of the correlation coefficients, for instance, by taking the mean value.

The evaluation method according to the invention can be experimentally checked by means of nuclear spin tomographic examinations of the brain of test subjects. A source of light, especially a matrix of light-emitting diodes (LED), is positioned directly in front of the face of the test subjects and then excited so as to emit flash signals. The frequency of excitation is 8 Hz. The effect of the signal flashes is exerted over a time interval—synchronized with the carrier signal of a scanner—of several seconds, for instance, 5 seconds, which is followed by a rest interval of approximately the same duration. The scanner is a Vision 1.5 Tesla, full-body scanner made by Siemens Medical Systems of Erlangen, Germany, in the standard version with a magnetic field gradient of 25 mT/m. Such a scanner is able to switch over gradient fields within about 150 μs.

The spectroscopic imaging method employed was TURBO-PEPSI (proton echo planar spectroscopic imaging).

Data adaptation was performed according to the exponential function:

S=S₀_{^{e}}^{(-TE/T}^{₂}^{^{*}}⁾ (25)

making use of a non-linear least-square-fit. Voxels in which the signal intensity during the first echo exceeded a value of 10% of the maximum signal amplitude measured in the entire image and where the correlation coefficient between the measured data and the fitted data exceeds 0.95 were then used to form parametric images of T₂^{*}, of the initial signal amplitude S₀ and of x².

In the other voxels, these parameters were set at 0. The use of these criteria led to excellent adaptations of the fitted data to the experimental results for all brain regions, except for the ventricles. In most of the voxels, the correlation coefficient exceeded the value of 0.99.

Alternatively, mean values of the echoes of each relaxation measurement are taken and subsequently a correlation analysis is conducted for the parametric images as well as for the images for which a mean value was taken.

The experiments showed widespread activation regions of the primary visual cortex (V₁) as well as in adjacent regions (V₂) of the visual cortex.

The invention entails a number of advantages. These include an optimization of the measuring sensitivity for a quantitative measurement of the relaxation time and of the qualitative change in the relaxation time. As a result, it is possible to employ an imaging procedure having the largest possible bandwidth (shortest encoding time) for the lowest possible spatial distortion and to obtain maximum measuring sensitivity by means of an optimal number of encodings following signal excitation.

The evaluation method can be used in real time measurements in order to allow an analysis of the relaxation changes in vivo. Advantageously, a measuring device according to the invention is designed in such a way that it carries out the evaluation method.

The imaging methods according to the invention are very versatile. It has proven to be advantageous to employ a summation, or even better, a weighted summation, which can be done more rapidly and without loss of measuring sensitivity in comparison to a curve adaptation. A summation or a weighted summation has the advantage of being a particularly reliable evaluation method.

Furthermore, the invention makes it possible to attain optimal adaptation of the measuring sensitivity in all measurement field strengths, particularly in the case of measurement field strengths ranging from 0.1 tesla to 15 tesla, in that, for example, the number of echo signals is selected as a function of the intrinsic relaxation time, whereby the number N is preferably chosen according to Formula 12.

All of the test subjects displayed a strong activation in the primary cortex (V₁) and in the adjacent regions. The changes observed in the functional signal measured using TURBO-PEPSI range from 3% to 20%, depending on the echo time, on the position and on the individual test person. The excitation has a maximum value in the vicinity of TE=T₂^{*}. A comparison between EPI and TURBO-PEPSI images with TE=72.5 ms showed very similar activation images.

When a correlation limit of 0.4 was used, even smaller signal changes with echo times of, for instance, 12.5 ms to 228 ms, were detected. The mean value formation for the correlation images reduces the intensity of noise effects in comparison to EPI. The spatial expansion of the activation zone and the number of increased correlation coefficients in the visual cortex rise with the number of summed up echoes. In experiments having a longer duration of excitation (7 to 12 seconds), larger correlation coefficients are obtained than in measurements involving shorter periods of excitation (for instance, 3 seconds). It was found that a particularly high gain in sensitivity can be achieved by a summation of the first, preferably the first 6 to 10, especially the first 8, echo signals corresponding to the plateau of the CNR curve in FIG. 2.

The gain in sensitivity is advantageous particularly for short-time measurements, especially for real-time measurements since a change in the relaxation can be effectively ascertained even with just a few measured values. In summary, it can be said that the multi-echo recording of the differential signal translates into optimal sensitivity for any desired magnetic field strengths.

The examples presented demonstrate the measuring device as well as the imaging method on the basis of NMR measurements involving the human brain. Naturally, both the measuring device as well as the evaluation method can be utilized to examine other samples of living or non-living material.

1. A measuring device comprising at least one recording means for recording measurement signals, and a transformation means for transforming the measurement signals into digital measurement data, characterized in that the recording means and/or the transformation means are designed in such a way that they record measurement signals with a different resolution at different times and/or at different locations and/or they transform the measurement signals differently.

2. The measuring device according to claim 1, characterized in that it comprises at least one control unit that serves to control the recording means and/or the transformation means.

3. The measuring device according to either claim 1 or claim 2, characterized in that it has at least one memory unit, whereby this memory unit contains information to differently transform the measurement signals into the measurement data.

4. Nuclear magnetic resonance tomograph, characterized in that it comprises at least one measuring device according to one of claims 1 through 3.

5. A measuring method with which measurement signals are recorded and transformed into digital measurement data, characterized in that measurement signals are recorded with a different resolution at different times and/or at different locations, and/or are differently transformed.

6. The method according to claim 5, characterized in that the measurement signals are differently recorded and/or differently transformed to an extent that corresponds to at least one model.

7. The method according to claim 6, characterized in that the model is laid down prior to the measurement.

8. The method according to either claim 5 or 6, characterized in that the model is changed during the measurement.

9. The method according to claim 8, characterized in that the model is changed on the basis of a previously defined starting model.

10. The method according to one of claims 5 through 9, characterized in that the measurement signals and/or the measurement data are compressed.

11. The method according to claim 10, characterized in that the compression of the measurement signals and/or the measurement data is varied for signals measured at different times and/or different locations.

12. An imaging method with which at least one image is generated from the measurement signals, characterized in that the method is carried out according to one of claims 5 through 11.
